(19) United States
(12) Patent Application Publication
(10) Pub. No.: US 2015/0325082 A1
(43) Pub. Date: Nov. 12, 2015

(54) METHODS OF ADMINISTERING A WAGERING GAME BASED ON COMPARISON OF STRAIGHTS WITH BETTING OPTIONS DEPENDENT UPON LENGTH OF STRAIGHT

(71) Applicant: Bally Gaming, Inc., Las Vegas, NV (US)

(72) Inventor: Roger M. Snow, Las Vegas, NV (US)

(21) Appl. No.: 14/312,556

(22) Filed: Jun. 23, 2014

Related U.S. Application Data
(63) Continuation-in-part of application No. 14/271,096, filed on May 6, 2014.

(51) Int. Cl. G07F 17/32; A63F 1/00

(52) U.S. Cl. CPC G07F 17/3244; A63F 1/00; G07F 17/3293; A63F 2001/005

(57) ABSTRACT

Methods of administering wagering games include comparing a longest alternating straight of a first set of cards with a longest alternating straight of a second set of cards. Systems, gaming tables, and electronic gaming machines may perform such wagering methods.

### CROSS-REFERENCE TO RELATED APPLICATION

This application is a continuation-in-part of pending U.S. patent application Ser. No. 14/271,096, filed May 6, 2014, entitled “METHODS OF ADMINISTERING A WAGERING GAME BASED ON COMPARISON OF STRAIGHTS,” pending, the disclosure of which is hereby incorporated herein in its entirety by this reference.

### FIELD

The disclosure relates generally to methods of administering wagering games for casinos and other gaming establishments, and related systems and apparatuses. More specifically, disclosed embodiments relate to methods of administering wagering games involving the comparison of straights having an alternating sequence.

### BACKGROUND

Poker is a popular wagering game played in casinos and other gaming establishments. Many house-banked variants of poker have been developed including, without limitation, five-card draw, five-card stud, seven-card stud, and other table games marketed under the commercial names MISSISSIPPI STUD™, TEXAS HOLD'EM™, ULTIMATE TEXAS HOLD'EM®, and LET IT RIDE®. Decks of 52 cards, with or without jokers or representations of cards are often used in playing these games.

In a standard deck of cards, there are four suits. Heart and diamond suits are typically a first color, and club and spade suits are typically a second color. It is a standard in the casino industry to use cards that have red colored hearts and diamonds suits, and cards that have black colored clubs and spade suits. Some manufacturers use different color pigments to illustrate suit symbols, such as burgundy or burnt orange instead of red, or dark brown or navy blue instead of black. Even when there are color variations, the heart and diamond suits are of the same first color and the club and spade suits are also of the same second color.

Poker games conventionally use a hierarchy of various hands based on statistical probabilities of obtaining the respective hands. For example, in some poker games that are five-card games, the following hands are ranked in order, from highest to lowest: royal flush, straight flush, four of a kind, full house, flush, straight, three of a kind, two pair, one pair, and high card. The hierarchy of combinations varies with the number of cards in the hand. Poker games rely on the rank of individual cards when the highest-ranking hand is a high card.

Since the number of cards employed in a particular poker game is fixed within certain practical limits, and various poker hands and their relative ranks are and have been well-established for over a century, evolution of the game of poker in terms of meaningful variations is somewhat constrained. However, there is a market for new and more interesting ways to play poker games with easy to understand and entertaining game play.

### BRIEF SUMMARY

In some embodiments, the present disclosure includes a method of administering a wagering game. The method includes accepting an ante wager of at least one tangible gaming chip at a designated wager area on a gaming table layout from at least one participating player, dealing a set of player cards from a set of physical playing cards to the at least one participating player at a playing card receiving area on the gaming table layout, dealing a set of dealer cards from the set of physical playing cards to a dealer card receiving area on the gaming table layout, allowing the at least one participating player to inspect the set of player cards associated with the at least one participating player, accepting a play wager of at least one tangible gaming chip at a play wager area on the at least one player position from the at least one participating player or an indication of folding from the at least one participating player where a maximum amount of the play wager is based upon a number of cards in a longest alternating straight of the set of player cards of the at least one participating player, and resolving the wager. Resolving the ante wager includes comparing only the longest alternating straight of the set of player cards of the at least one participating player with a longest alternating straight of the set of dealer cards, and paying a payout on the ante wager and the play wager comprising at least one tangible gaming chip to the at least one participating player when the longest alternating straight of the set of player cards has a greater number of cards than the longest alternating straight of the set of dealer cards.

In some embodiments, the house permits the player to fold or make a play wager after viewing the player cards, but before the dealer cards are revealed.

In some embodiments, the play wager is made in an amount that is a multiple of the ante wager that is dependent upon the number of cards in the player hand (e.g., the number of cards in a longest alternating straight of the set of player cards).

In some embodiments, a bonus wager (e.g., a mandatory bonus wager required to participate in the game, which may be in addition to another optional bonus or side wager offered in the game) may be accepted from the player that pays a payout when the player hand beats the dealer hand, and where the amount won is dependent upon a margin of victory of the player hand. The margin of victory may be designated as a difference in the number of cards forming the dealer and player straights where the number of player cards exceeds the number of dealer cards.

One or more additional bonus or side bets may be offered with the game. For example, a side bet may be offered that pays when the player hand is an alternating straight of a minimum number of cards, such as a minimum of three cards, for example. The side bet may pay odds payouts for varying numbers of cards in the straight, as long as the straight has the minimum number of cards or more cards.

In additional embodiments, the present disclosure includes a method of administering a wagering game. The method includes accepting a wager of at least one tangible gaming chip at a designated wager area on a gaming table layout from at least one participating player, accepting a bonus wager of at least one tangible gaming chip at a designated bonus wager area on the gaming table layout from the at least one participating player, dealing a set of player cards from a set of physical playing cards to the at least one participating player at a playing card receiving area on the gaming table layout, dealing a set of dealer cards from the set of physical playing cards to a dealer card receiving area on the gaming table layout, allowing the at least one participating player to inspect the set of player cards associated with the at least one participating player, and resolving the wager. Resolving the wager includes comparing only a longest alternating straight of the set of player cards of the at least one participating player with a longest alternating straight of the set of dealer cards, and paying a payout on the wager comprising at least one tangible gaming chip to the at least one participating player when the longest alternating straight of the set of player cards has a greater number of cards than the longest alternating straight of the set of dealer cards. The method further includes resolving the bonus wager comprising paying a payout on the bonus wager comprising at least one tangible gaming chip to the at least one participating player when the longest alternating straight of the set of player cards of the at least one participating player includes at least two more cards than the longest alternating straight of the set of dealer cards.

In additional embodiments, the present disclosure includes a method of administering a wagering game. The method includes providing a gaming table layout comprising at least one player position and a dealer area, the at least one player position of the gaming table layout including an ante wager area, a play wager area, a bonus wager area, and a player card receiving area, the ante wager area, the play wager area, and the bonus wager area each defined by separate insignia displayed on the gaming table layout, the dealer area including a dealer card receiving area. The layout may also include an additional bonus wager area (e.g., a Super Bonus betting area). The method further includes accepting an ante wager of at least one tangible gaming chip at the ante wager area from at least one participating player at the at least one player position and optionally accepting a bonus wager of at least one tangible gaming chip at the bonus wager area from the at least one participating player at the at least one player position. In some embodiments, the dealer may also accept an additional bonus wager (e.g., a mandatory Super Bonus wager from the player to participate in the game). The further method includes dealing a set of player cards from a randomized set of physical playing cards to the at least one participating player at the player card receiving area at the at least one player position, dealing a set of dealer cards from the randomized set of physical playing cards to the dealer card receiving area at the dealer area, allowing the at least one participating player to inspect the set of player cards associated with the at least one participating player, and accepting a play wager of at least one tangible gaming chip at the play wager area from the at least one participating player at the at least one player position or an indication of folding from the at least one participating player. In some embodiments, the play wager may be a multiple of the ante, where the amount of the multiple (e.g., the maximum amount of the multiple) depends upon the number of cards in the player hand that form an alternating straight. The method further includes determining a longest alternating straight with the set of player cards of the at least one participating player comprising a sequence of cards where each card is of a differing color than an adjacent card in the sequence of cards. The method further includes determining a longest alternating straight with the set of dealer cards comprising a sequence of cards where each card is of a differing color than an adjacent card in the sequence of cards, resolving the ante wager, the play wager, and the bonus wager, if made. Resolving the ante wager and the play wager includes at least one of paying a payout comprising at least one tangible gaming chip on at least one of the ante wager and the play wager to the at least one participating player when the longest alternating straight of the set of player cards has a greater number of cards than the longest alternating straight of the set of dealer cards. The method includes retaining the ante wager and the play wager when the longest alternating straight of the set of player cards of the at least one participating player is shorter than the longest alternating straight of the set of dealer cards. Resolving the bonus wager includes at least one of paying a bonus payout comprising at least one tangible gaming chip on the bonus wager to the at least one participating player when the longest alternating straight of the set of player cards comprises at least three cards and retaining the bonus wager if the longest alternating straight of the set of player cards comprises less than three cards. If a Super Bonus bet is required, that bet is also resolved.

In some embodiments, the ante and play wagers are also retained when the longest alternating straight of the set of player cards of the at least one participating player is of equal length to the longest alternating straight of the set of dealer cards and a highest-ranking card of the longest alternating straight of the set of player cards of the at least one participating player is of equal or lower rank than a highest-ranking card of the longest alternating straight of the set of dealer cards. In other embodiments, when the number of player and dealer cards in each run are equal, and a highest-ranking card in each run (i.e., the kicker) is of equal rank, the hands are a copy of each other and all wagers push.

In yet additional embodiments, the present disclosure includes a method of administering a wagering game over a network utilizing a processor. The method includes receiving, at a processor, an indication that an ante wager to participate in the wagering game is accepted from at least one player. The method includes determining, utilizing the processor, a player hand associated with the at least one player, the player hand including at least two randomized playing cards from a set of playing cards. The method also includes determining, utilizing the processor, a dealer hand, the dealer hand including at least two randomized playing cards from the set of playing cards. Additionally, the method includes providing, with the processor, the player hand to a user device associated with the at least one player for displaying the player hand on the associated user device, and determining, utilizing the processor, a longest alternating straight of the player hand comprising a sequence of cards where each card is of a differing color than an adjacent card in the sequence of cards and receiving, at the processor, an indication that a play wager based upon a number of cards in the longest alternating straight of the player hand is accepted from the at least one player or an indication of folding from the at least one player. The method further includes determining, utilizing the processor, a longest alternating straight of the dealer hand where each card is of a differing color than an adjacent card in the sequence of cards. The method includes providing, with the processor, the dealer hand to the user device associated with the at least one player for displaying the dealer hand on the associated user device, and resolving the ante wager and the play wager by comparing a number of cards in the longest alternating straight of the player hand with a number of cards in the longest alternating straight of the dealer hand.

Embodiments that implement a Super Bonus wager and that pay for margins of victory may be also be practiced over a network.

Yet other embodiments may comprise apparatuses and systems for administering wagering games according to embodiments of the disclosure.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which

FIG. 1 is a flowchart diagram of a method of administering a wagering game;

FIG. 2 is a diagram of a playing surface for implementation of the wagering game;

FIG. 3 is an enlarged diagram of one of the player positions of the playing surface of FIG. 2;

FIG. 4 is a perspective view of a gaming table configured for implementation of embodiments of wagering games in accordance with this disclosure;

FIG. 5 is a perspective view of an individual electronic gaming machine configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of wagering games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 is a flowchart diagram of a method of administering a wagering game, which may be at least partially player-pooled, according to a player-pooled progressive embodiment;

FIG. 12 is a flowchart diagram of a method of administering a wagering game, which may also be at least partially player-pooled, according to a dividend refund embodiment;

FIG. 13 is a schematic of a scratch card implementation of a wagering game in accordance with this disclosure;

FIG. 14 is a flowchart diagram of another method of administering a wagering game; and

FIG. 15 is an enlarged diagram of another player position of a playing surface for implementation of the wagering game.

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games, the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked,” “player-banked,” “player-pooled” including “player-pooled progressive,” and “dividend refund” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local gaming establishment, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

As used herein, the term “straight” means a group of cards that are ordered in rank sequentially, with each successive card being exactly one rank above a preceding card in the group. For example, in a conventional 52-card deck of cards, the cards may be ranked as follows, from lowest rank to highest rank: 2, 3, 4, 5, 6, 7, 8, 9, 10, jack, queen, king, and ace. In some embodiments, the ace may act as a low card (e.g., having a rank value of less than 2). In other embodiments, the ace may act as a high card (e.g., having a rank value higher than a king) or as both a low card and a high card. In some embodiments, a group of cards may form a so-called “wrap-around straight,” such as a four-card straight consisting of the cards king, ace, 2, and 3, for example.

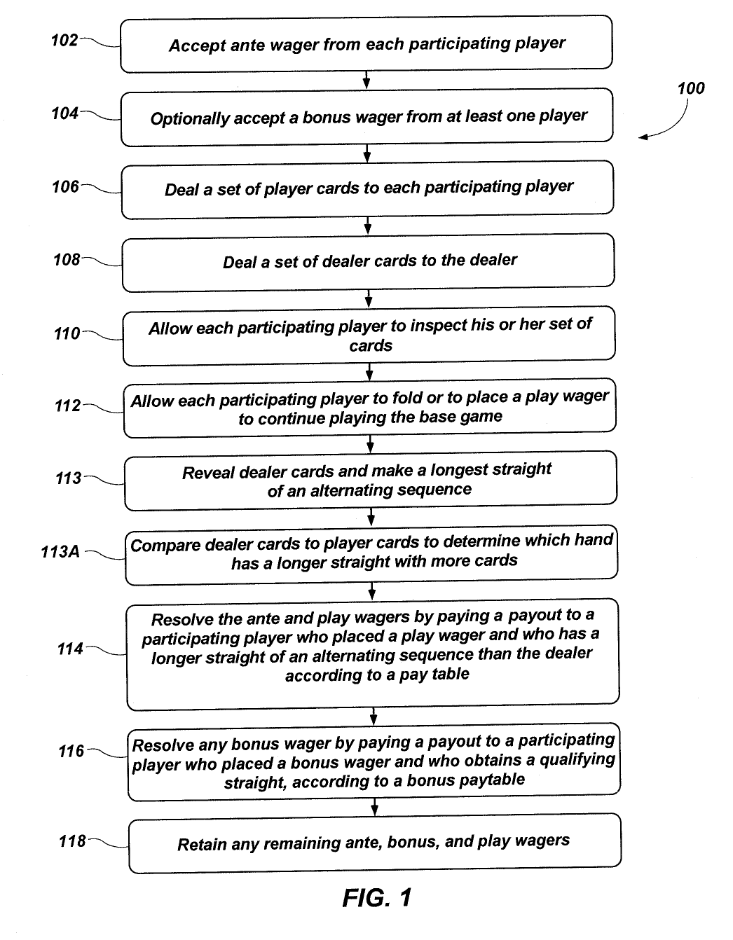

Referring to FIG. 1, a flowchart diagram of a method 100 of administering a wagering game is shown. Generally, the method 100 includes administering a wagering game in which one or more winners may be determined by comparing card sequences (e.g., straights) of at least two sets of cards where each straight includes at least one alternating color such as the color of the suit. For example, each alternating straight may include a sequence of alternating colors (e.g., alternating suits of black and red). Typically hearts and diamond suit symbols are red in color, while clubs and spade symbols are black in color. In other words, in order to form a strong hand, each sequential card in the alternating color straight will alternate such that the color of each card will be different from the adjacent cards. For example, the entire straight may be formed of cards with alternating colors where each card has a differing color from one or both adjacent cards in the straight (it will be appreciated that the first card and the last card in the straight will have a differing color from only one adjacent card).

Such an alternating color straight may be formed by a sequence of cards where cards forming the odd numbers in the sequence of cards (e.g., one or more of the first card, the third card, the fifth card, the seventh card, etc., in the alternating straight) are a first color (e.g., red or black) and the cards forming the even numbers in the sequence of cards (e.g., one or more of the second card, the fourth card, the sixth card, etc., in the alternating straight) are a second color that is different than the first color (e.g., red or black). As a specific, non-limiting example, an alternating color straight may be formed be a sequence of 9, 10, jack, and queen where the 9 and jack comprise a red color (e.g., having a suit of hearts or diamonds) and where 10 and queen comprise a blank color (e.g., having a suit of spades or clubs).

In some embodiments, the suits of the cards may designate the alternating characteristics of the cards in the alternating straight (e.g., cards having red or black suits). In other embodiments, other indicia or colors of the cards may be utilized as the alternating characteristic of the cards. For example, the deck of cards may be specifically designed with at least two differing color or other indicia designations. While, the alternating characteristic is discussed above and herein with a 1:1 ratio, in other embodiments, other ratios may be utilized (e.g., 1:2, 2:2, 2:3, etc., or combinations thereof).

The method 100 may begin with the acceptance by the dealer from a player of an ante bet, or receiving an indication that an ante bet has been made or received from each participating player, or at a location associated with a particular player, as indicated at operation 102. The ante wager may be accepted from each player wishing to participate in the upcoming wagering game (which may represent the start of one game play). A game session may comprise one or more individual game plays. When multiple players are participating in the same game, all player cards are typically dealt from the same deck, and the dealer accepts all player wagers before card distribution begins.

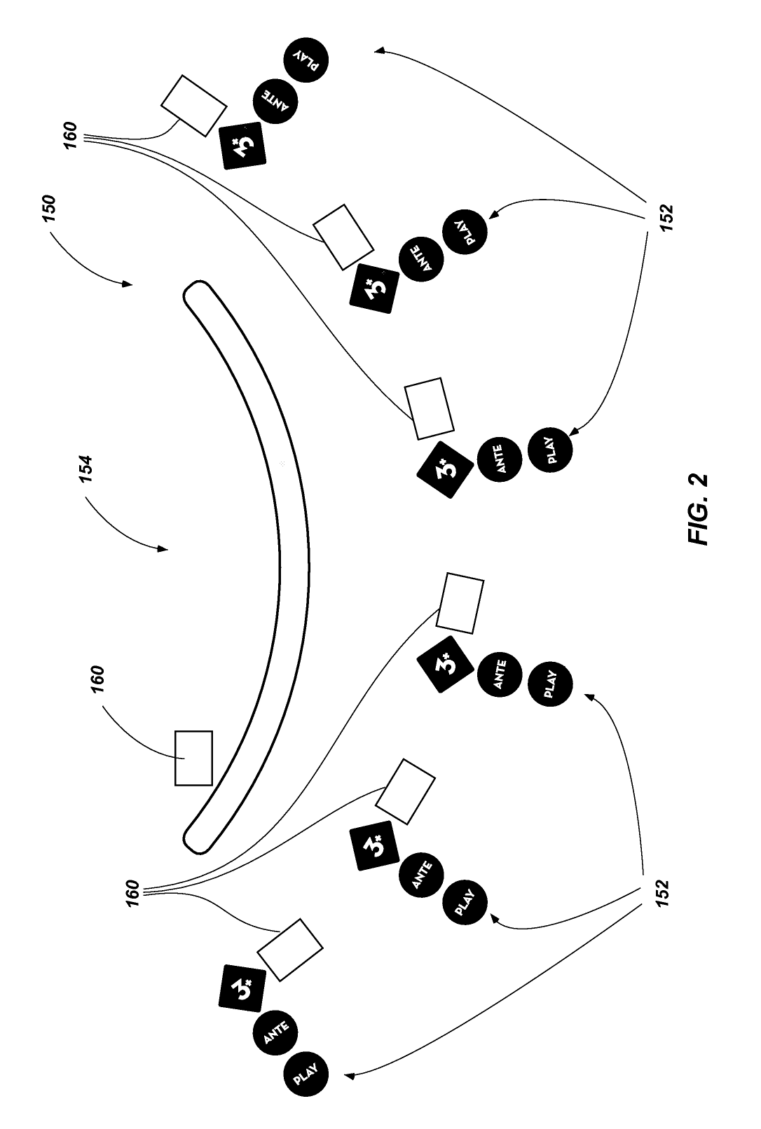

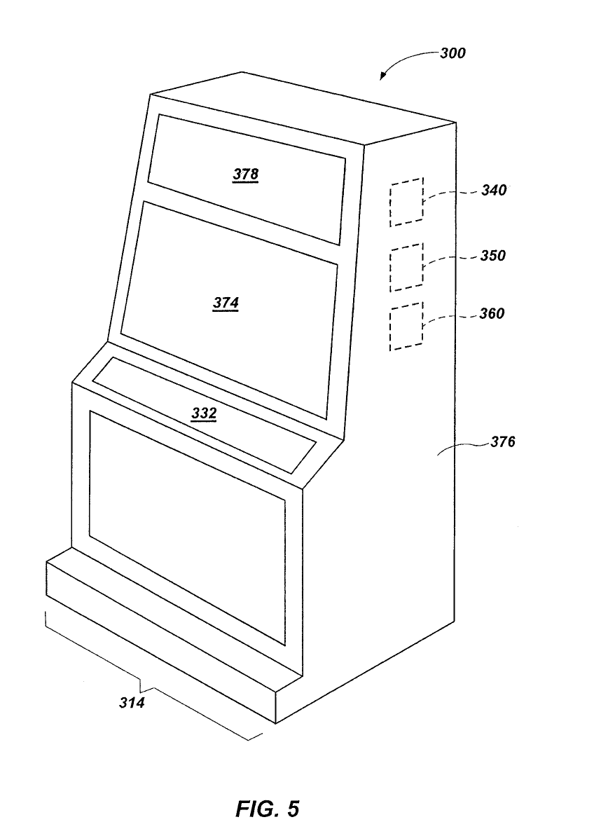

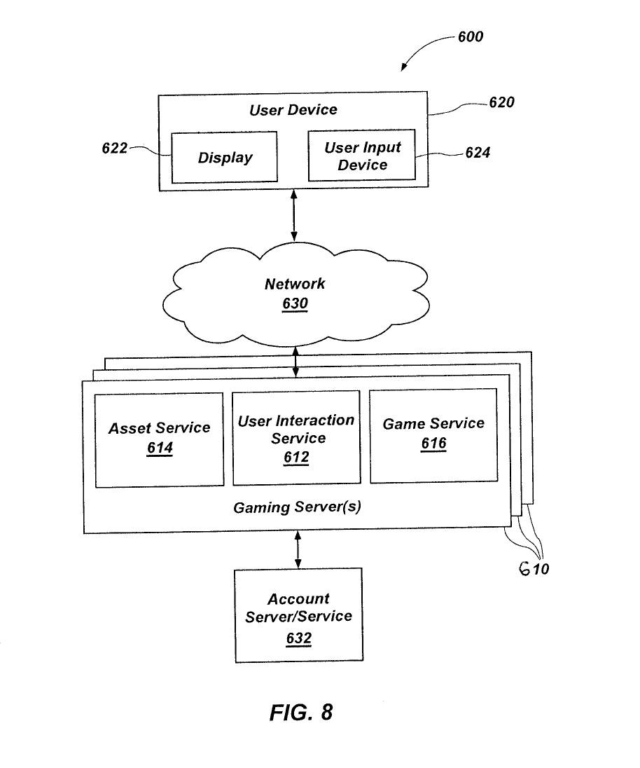

As a specific, non-limiting example, the individual players may begin a gaming session at an electronic gaming table 150, 400, or 500 (see FIGS. 2, 6, and 7) (e.g., by logging into a player account, or by inserting currency into a currency acceptor, by inserting a ticket in a ticket in/ticket out reader, by swiping a player account card) and interact with personal interface devices 332, 416, 532, 620, 640, (see FIGS. 5 through 10) (e.g., touch screens, keyboards, buttons, switches, etc.) to authorize placement of the ante wager. The ante wager may be provided, for example, by placing physical money or physical representations of money (e.g., chips) in a designated area of a gaming table 150, 400, 500 (see FIGS. 2, 6, and 7), by displaying digital representations of money in a designated area of at least one display screen 374, 416, 430, 532, 560, 564, or 658 (see FIGS. 5 through 7 and 10), or by displaying a monetary amount of the first wager on at least one display screen 374, 416, 430, 532, 560, 564, or 658 (see FIGS. 5 through 7 and 10), which may be remotely located from a dealer or game server 610 (see FIG. 8).

The ante wager may be accepted, for example, by electronically accepting funds from a player account or other credit authorized via one or more communications media (e.g., via the Internet, wireless communications, land line) on a remote electronic device (e.g., a personal computer, a laptop, a tablet computer, or a smartphone) by player input; electronically accepting funds from a player account authorized on a local wagering game administration device in a casino by player input; or physically placing money or representations of money (e.g., chips) on a table at a live game in a casino. Suitable network architecture for electronically accepting funds from a player account authorized on a remote device may comprise, for example, the network gaming architecture disclosed in U.S. patent application Ser. No. 13/353,194, filed Jan. 18, 2012, to Costello et al., and U.S. patent application Ser. No. 13/609,031, filed Sep. 10, 2012 to Costello et al., the disclosure of each of which is incorporated herein in its entirety by this reference. Suitable local wagering game administration devices may comprise, for example, the chipless tables disclosed in U.S. Pat. No. 8,262,475, issued Sep. 11, 2012 to Snow et al., the disclosure of which is incorporated herein in its entirety by this reference.

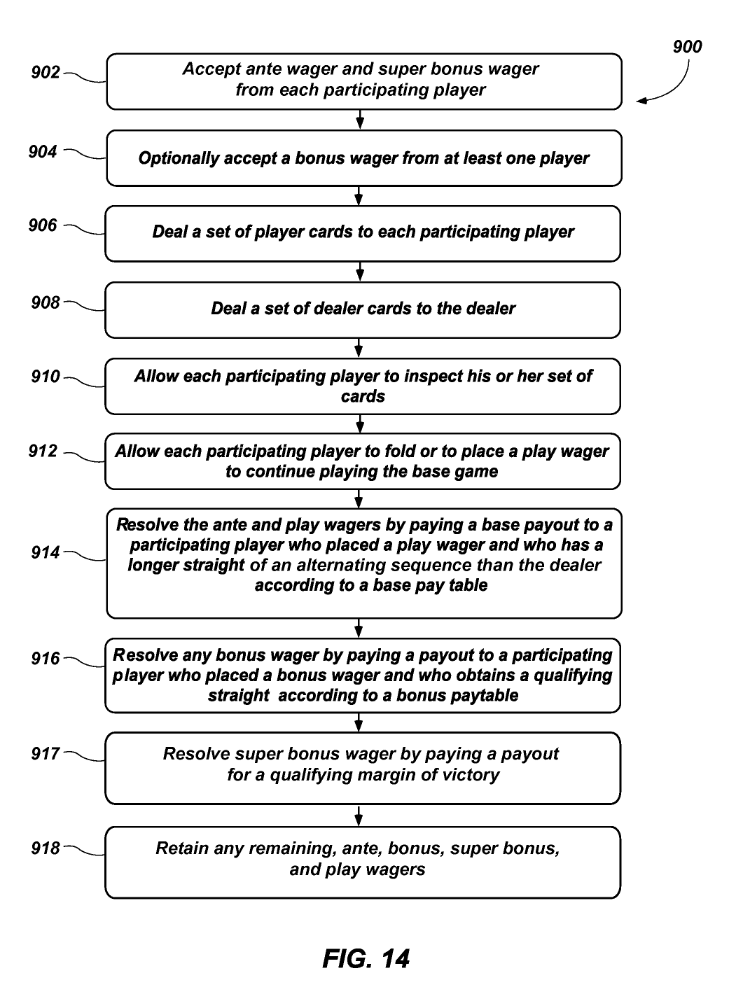

In some embodiments, optionally, one or more bonus wagers (e.g., side bets) may be accepted from at least one participating player, as indicated at operation 104. The bonus wagers may be accepted before any cards are dealt, or at least before the at least one participating player is allowed to inspect his or her player cards. The bonus wagers may include, for example, a wager that the player cards of the at least one participating player will include an alternating straight of a minimum number of cards (e.g., at least three cards, at least four cards). An alternating straight having an even greater length may qualify the at least one player for a higher bonus payout, as will be explained in more detail below. In some embodiments, and as discussed below with reference to FIG. 14, a bonus wager (e.g., in addition to or alternative to the bonus wager based on the minimum number of cards in the player had discussed above) may be accepted that is based on margin of victory of the player hand over the dealer hand.

After the ante wager and any bonus wagers, if implemented, have been accepted, player cards may be dealt to each participating player, as indicated at operation 106. By way of example, and not limitation, seven player cards may be dealt to each participating player, although any predetermined number of cards may be dealt to each participating player as dictated by game or house rules (e.g., two to six cards, seven cards, eight or more cards). For example, physical cards that have been randomized (e.g., by manual or automated shuffling) may be distributed sequentially to each participating player, the order of which may be dictated by a set of game or house rules. In additional embodiments, digital representations of cards (e.g., images resembling physical cards or characters and symbols) may be displayed on personal display screens 374, 416, 532, or 658 (see FIGS. 5 through 7 and 10) for individual players. In some embodiments, the electronically generated cards may be displayed, for example, to remote players over networks.

The player cards may be dealt face down at a gaming table and in electronic implementations may only be visible to the individual player to whom the set of player cards was dealt. It is understood that “face down” may refer to physical playing cards that are in a face down orientation or digital indications or representations of cards that may show card backs and whose faces are not yet revealed to one or more participating players. In other embodiments, one, two, or more of the player cards may be made visible to both the player to whom they were dealt and other participating players, for example, by dealing some or all of the player card(s) face up. Further embodiments may involve dealing any predetermined or selected number of cards face up, up to and including all of the cards dealt to each individual player.

Another set of cards against which each participating player's set of playing cards is to be played (e.g., dealer cards) may be dealt face down, such as in front of the dealer, as indicated at operation 108. In some embodiments, one or more of the dealer cards may be dealt face up to provide a perceived or actual advantage to the participating player(s). In some embodiments, all player and dealer cards may be dealt at the same time as packs of randomized cards. In other embodiments, cards can be delivered individually to each participating player card position and to the dealer card position until a predetermined number of cards is given to each participating payer and to the dealer.

Each participating player may be allowed to inspect his or her set of player cards, as indicated at operation 110 (e.g., prior to revealing the dealer cards) and arrange the cards into the longest straight of alternating suit color. The remaining cards may be set aside or discarded and are not used to resolve the ante, play or bonus bets. After inspecting his or her set of player cards, each participating player may be allowed to fold or place a play wager to continue playing the game, as indicated at operation 112. Thus, a play wager (e.g., a raise wager) may be accepted from each participating player who decides not to fold. In some embodiments, the play wager may be based the ante wager (e.g., a multiple of the ante wager). In some embodiments, the amount of the play wager (e.g., the maximum amount of the multiple of the ante wager) may depend upon the number of cards in the player hand that forms an alternating straight. For example, the maximum allowed play wager may be based on a multiple (e.g., a multiple of the ante wager) where the maximum allowed multiple is dependent on the number of cards in the player hand forming the alternating straight. Such maximum allowed play wager multiples may be defined as shown in Table I.

TABLE I

| Number of Cards | Maximum Play Wager |
|---|---|
| 1 or 2 | 1x |
| 3 | 3x |
| 4 | 4x |
| 5 | 5x |
| 6 | 6x |
| 7 | 7x |

In some embodiments, the player may make a play wager of any multiple up to the defined maximum play wager multiple as dictated by the number of cards forming the alternating straight in the player hand. In other embodiments, the player may be required to make a play wager of the defined maximum play wager multiple as dictated by the number of cards forming the alternating straight in the player hand.

Each of the participating players may decide whether to fold or continue to play based on his or her player cards and whether he or she believes that there is a good chance at achieving a longer alternating color straight or at least an alternating color straight of equal length when comparing the respective player hand to the dealer hand, as will be explained in more detail below. For example, a participating player that has a relatively long alternating color straight (e.g., four consecutive player cards) will likely decide to place a play wager to continue playing, while a participating player with a longest alternating straight that is relatively short (e.g., two consecutive player cards of alternating color) will likely decide to fold to reduce potential losses. Hands that have straights of the same color or suit have no value in games of the present invention.

After each participating player has folded or placed a play wager, the set of dealer cards may be revealed 113, and the set of player cards of each participating player who placed a play wager may be compared 113a to the set of dealer cards. For example, the set of player cards of each participating player who placed a play wager and the set of dealer cards may be arranged in a sequential rank order to form a longest alternating color straight for each participating player and the dealer. The formed longest alternating color straights of each participating player may then be compared to the faulted longest alternating color straight of the dealer. In some embodiments, any cards not used in the longest alternating color straight may be discarded or otherwise set aside.

In some embodiments, the dealer hand may be required to meet one or more predetermined criteria. For example, the dealer hand may be required to have an alternating straight of a predetermined length (e.g., at least two cards) and/or an alternating straight having at least a predetermined highest card (e.g., an alternating straight ending in a card rank of 5, 6, etc.). In such an embodiment, if the predetermined length and/or highest card of the alternating straight is not met by the dealer hand, the dealer may be required to perform one or more actions in relation to the wagers of each participating player. For example, when the predetermined length of the alternating straight is not met by the dealer hand, the dealer may return one or more wagers (e.g., the ante wager) to each participating player and the remaining wagers, if any (e.g., the play wager, the bonus wager, if implemented) stay in action.

The ante and play wagers of each participating player who placed a play wager may be resolved based on the comparison, as indicated at operation 114. In one embodiment, both the ante and play wagers are considered base game wagers. For example, each participating player may be paid a payout on the ante and play wager according to predetermined fixed odds (e.g., 1:1, 2:1, 3:1, etc.). In other embodiments, payout of one or more of the ante and play wagers may be based on a pay table.

If the participating player's longest alternating straight is greater than the dealer's longest alternating straight (e.g., the number of cards in the player's alternating straight is greater than the number of cards in the dealer's alternating straight), the participating player may receive a payout on one or more of their wagers (e.g., the ante wager and the play wager).

If the participating player's longest alternating straight is less than the dealer's longest alternating straight (e.g., the number of cards in the player's alternating straight is less than the number of cards in the dealer's alternating straight), one or more of participating player's wagers (e.g., the ante wager and the play wager) may be retained by the dealer and/or gaming establishment.

In the event that a participating player's longest alternating straight includes an equal number of cards as the dealer's longest alternating straight, a predetermined tiebreaker may be settled to determine whether or not the participating player qualifies for a payout. This situation includes an event in which the player and the dealer each have no alternating straight (i.e., no two consecutively ranked cards with an alternating color sequence), in which case the predetermined tiebreaker may also determine whether the participating player qualifies for a payout. By way of example and not limitation, the ranks of respective highest-ranking card of the player's longest alternating color straight and of the dealer's longest alternating color straight (or only the highest-ranking card of the hand where the player and the dealer each have no alternating straight) may be compared to settle the tiebreaker. The highest-ranking card in the alternating straight of cards may be determined when the alternating straight of cards is counted sequentially from a bottom of the alternating straight to a top of the alternating straight. For example, the highest-ranking (i.e., final) card of a 4-5-6-7 alternating straight is a 7, while the highest-ranking (i.e., final) card of a 10-J-Q-K alternating straight is a king, which has a higher rank than a 7.

If the final cards of the respective player's longest alternating color straight and the dealer's longest alternating color straight are equal, such as when the player and the dealer each hold an alternating color straight of equal rank (e.g., each having the same highest-ranking card) with the same cards defining the respective alternating straights having different suits (or the same suits when multiple decks are implemented), game rules may indicate the winner of such a tie. In some embodiments, it may be predetermined that such a tie results in the casino or other gaming establishment retaining the ante and play wager of the player or, alternatively, that such a tie results in the participating player to receiving a payout (e.g., of one or both of the ante and play wagers). In other examples, ties may result in a push of one or more of the ante and play bets. By way of additional examples, the predetermined tiebreaker may be settled by comparing highest ranked cards in the respective longest alternating color straights of the player and of the dealer or by comparing the player's second longest alternating color straight with the dealer's second longest alternating color straight. Thus, the ante and play wager of each participating player from whom a play wager was accepted may be resolved by paying a participating player who achieves a longer alternating color straight than the dealer or who achieves an equal alternating color straight with a predetermined tiebreaker settled in the player's favor, and/or by retaining the ante and play wager of the participating player who has a lower longest alternating color straight than the dealer or a longest alternating color straight of equal length as the dealer's longest alternating color straight but who loses the predetermined tiebreaker.

The bonus wager may be resolved according to a bonus pay table and based on whether the set of player cards of each participating player from whom a bonus wager was accepted includes a longest alternating color straight of a predetermined minimum number of cards (e.g., an alternating color straight of at least three cards), as indicated at operation 116. A bonus payout may be paid to a qualifying participating player according to a bonus pay table. For example, payout of the bonus wager may be based on the number of cards in a longest alternating straight of the player's set of player cards according to the odds shown in Table II.

TABLE II

| Number of Cards In | |
|---|---|
| Alternating Straight | Bonus Payout |
| 7 Cards | 500 to 1 |
| 6 Cards | 50 to 1 |
| 5 Cards | 15 to 1 |
| 4 Cards | 6 to 1 |
| 3 Cards | 3 to 1 |

If the longest alternating color straight of the participating player who paid a bonus wager includes fewer cards than the predetermined minimum number of cards, then the bonus wager of that player may be retained, such as by the casino or other gaming establishment. In some examples, the bonus wager may be resolved independently from the ante and/or play wager and regardless of whether the dealer received a fold election from the participating player or whether the dealer paid the player a payout on the ante and play wagers. In other examples, the player may only qualify to win the bonus payout if the player made a play wager.

After the ante wager, bonus wager (if any), and play wager (if any) have been resolved and winning payouts paid to any qualifying participating player(s), any losing ante, bonus, and play wagers may be retained by the casino or other gaming establishment, as indicated at operation 118. As will be explained in more detail below, alternatively, the operation 118 of retaining the wagers may be replaced by an operation of periodically returning at least a portion of an accumulating pot comprising multiple wagers to one or more participating players, rather than to the casino or other gaming establishment.

Certain game rules may provide an advantage to the casino or other establishment. For example, as discussed above, the advantage may be provided to the casino or other establishment by allowing a tie to go to the casino or other establishment (e.g., where the alternating straights formed by one or more players' hand and the dealer hand are the same length with the same rank high card). In other embodiments, ties or copies may be resolved in the player's favor or in a push. In some embodiments, the advantage may be provided to the casino or other establishment by dealing at least one more card to the dealer than to each participating player. For example, in an embodiment in which each participating player is dealt seven cards, the dealer may be dealt eight cards. In yet other embodiments, a random number of cards are dealt to the players, the dealer, or both. In some embodiments, the advantage may be provided to the casino or other establishment by adjusting payout odds in favor of the casino or other establishment, and/or by allowing the casino or other establishment to withhold a portion of every wager, such as by taking a rake (i.e., a certain percentage) of each ante wager. In such embodiments, the dealer may be dealt an equal number of cards as the set of player cards of each participating player. In yet other embodiments, adding a dealer qualification rule may increase the house advantage. For example, in one embodiment, the dealer must have at least a two-card alternating color straight otherwise the ante is returned to each player. All other wagers remain in action according to this embodiment.

In some embodiments, an optional insurance wager may be accepted from at least one participating player. For example, the insurance wager may include a wager that the player cards and/or the dealer cards will not include an alternating straight of a selected number of cards (e.g., at least two cards, at least three cards).

Although the method 100 of administering a wagering game illustrated in FIG. 1 has been described as following a particular sequence, the present disclosure is not so limited. In some embodiments, such as embodiments in which multiple players participate and the individual sets of player cards are to be kept face down and not reviewed by other players until after a decision to fold or place a play wager has been made, the operation 116 of resolving the bonus wager may be performed after allowing each player to fold or place a play wager (operation 112). Thus, any outstanding bonus wager may be resolved at any convenient time during a game round after a bonus wager has been accepted from at least one participating player and the at least one participating player has inspected his or her respective set of cards.

Various platforms are contemplated that are suitable for implementation of embodiments of wagering games according to this disclosure. For example, embodiments of wagering games may be implemented as live table games with an in-person dealer, electronic gaming machines, partially or fully automated table games, and fully automated, network-administered games (e.g., Internet games) that either produce game results utilizing a processor, or produce a live video feed of a dealer administering a game from a remote studio. By way of further example, wagering games may be implemented on gaming tables, which may include physical gaming elements, such as physical cards and physical chips, printed betting circles and other designated play areas, and may include a live dealer and a shuffler or shoe. More specifically, a live dealer may deal physical cards, evaluate hands, accept wagers, accept player elections, issue payouts, retain wagers, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

Referring to FIG. 2, an exemplary diagram of a playing surface 150 (also referred to as “gaming table layout 150”) having one or more player positions 152 and a dealer card position 154 for implementation of the wagering games within the scope of the present disclosure is shown. Such an implementation may include a felt layout with printed markings on a physical gaming table or an electronic representation of a felt layout on a video display screen (see, e.g., FIGS. 5 through 7 and 9) for each participating player position 152. The playing surface 150 may define a plurality of the participating player positions 152 within which the activity (e.g., wagering and card dealing) for individual players may take place. The dealer card position 154 may be a position where dealer cards may be dealt. For example, the dealer card position 154 may include an area where a number of cards of a dealer hand may be dealt and positioned, such as an area sufficiently large to position seven cards side by side in a row.

As depicted, one or more of the participating player positions 152 and the dealer card position 154 may include one or more indicia related to the wagering game. For example, each of the participating player positions 152 and the dealer card position 154 may include a pay table 160 indicating the odds associated with the payouts for one or more of the wagers (e.g., the bonus wager).

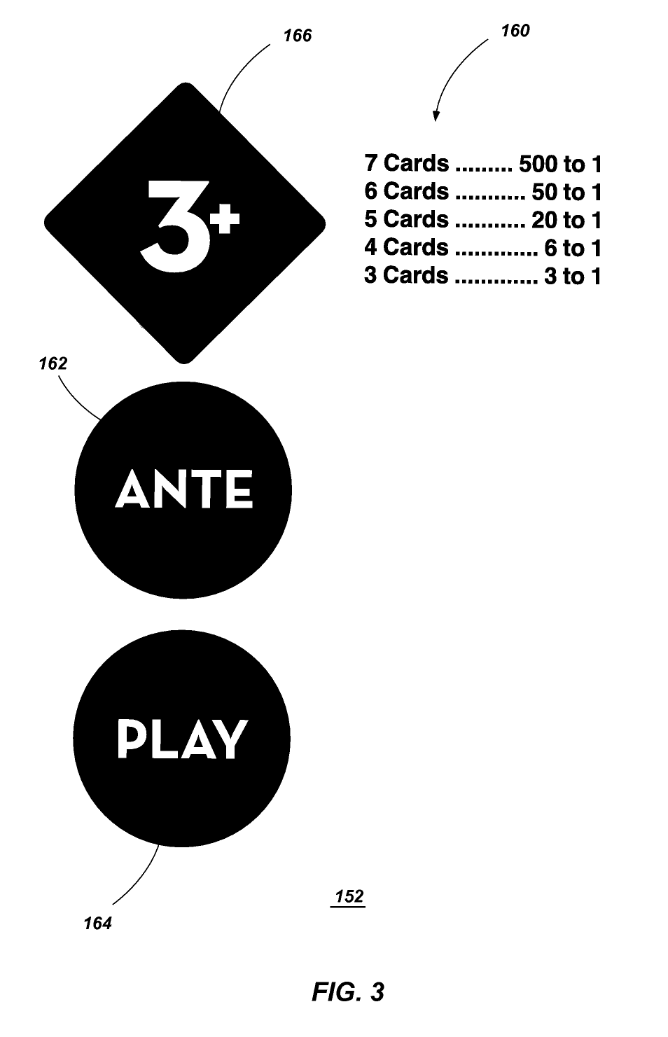

Referring to FIG. 3, an enlarged diagram of one of the player positions 152 of the playing surface 150 of FIG. 2 is shown. Each player position 152 may include an ante wager region 162 within which money or representations of money may be placed or displayed (e.g., physically positioned or digitally displayed) when the ante wager is accepted. Each player position 152 may also include a play wager region 164 within which a play wager may be placed when the participating player decides not to fold and the play wager is accepted. Each player position 152 may also include a bonus wager region 166 within which a bonus wager may be placed or displayed when the bonus wager is accepted. In one embodiment, the minimum winning bonus hand is an alternating color straight of three cards or more. For this reason, the bonus wager region 166 may be labeled “3+”. In some embodiments, the bonus wager region 166 may be positioned proximate to a pay table 160, which may display the payout odds associated with each winning bonus hand. As is known in the art, the odds are multiplied by the amount wagered to determine a payout amount.

In some embodiments, one or more of the wager regions may include sensors to automatically sense the presence and/or the value of a wager.

With combined reference to FIGS. 2 and 3, a specific implementation of the wagering game described in connection with FIG. 1 is presented. An ante wager may be accepted from each participating player position 152 by receiving money or representations of money (e.g., chips) in the ante wager region 162. Optionally, a bonus wager may be accepted by receiving money or representations of money in the bonus wager region 166. For example, the dealer may accept an optional bonus wager in region 166. After the ante wager and, optionally, the bonus wager have been accepted by placing the wagers in the respective positions, a number of player cards (e.g., five player cards, six player cards, seven player cards, or more or less) may be dealt to a player card position (e.g., below, above, or on the player position 152 in the perspective of FIG. 3) of each participating player position 152. In some embodiments, the seven player cards may be dealt face up, while in other embodiments the seven player cards may be dealt face down. In further embodiments, one or more player cards may be dealt face up, while one or more additional player cards of the seven may be dealt face down. An equal number of dealer cards (e.g., seven) may be dealt to the dealer card position 154, face down. In some embodiments, one or more dealer cards of the seven dealer cards may be dealt face up, to provide the player with a perceived or actual advantage of knowing the identity of one of the dealer cards.

After allowing each participating player to inspect his or her set of player cards, referring to FIGS. 1 through 3, the dealer may receive an election from each participating player to fold and surrender any outstanding ante wager or receive a play wager in the underlying or base game. For example, the dealer may receive an indication from the player that he or she wishes to fold by observing the player passing his or her respective player hand, face down, on the playing surface 150 above the player's player position 152 and toward the dealer. If a participating player decides to continue play, the dealer may accept a play wager placed by the player in the play wager position 164. In some embodiments, the allowable amount of the play wager may be equal to the ante wager. In other embodiments, the play wager may be a specific multiple of the play wager, may be selected from a group of allowable multiples of the play wager, or may be any amount with or without an upper and/or lower limit, but within table limits. After the dealer has received fold or continue play election by receiving a play wager, the face down dealer cards in the dealer card position 154 may be revealed.

After the dealer cards are revealed, the set of player cards of each participating player that placed a play wager may be compared to the dealer cards to decide whether the respective player hands include an alternating color straight having a number of cards greater than a longest alternating color straight formed from the dealer cards. In some embodiments, when a player's longest alternating color straight is equal in length to the dealer's longest alternating color straight, a predetermined tiebreaker may be settled to determine whether or not the player wins and qualifies for a payout. For example, the player's longest alternating color straight and the dealer's longest alternating color straight may be evaluated to determine whether the final card of the player's longest alternating color straight (e.g., the highest card of the alternating straight) is higher than or of equal rank to the final card of the dealer's longest alternating color straight, as explained above.

After the dealer's longest alternating color straight and each player's longest alternating color straight are compared and the tiebreaker (if any) is settled, the ante wager and the play wager may be resolved according to, for example, predetermined odds (e.g., 1:1). If a participating player does not achieve a winning hand, any portion of that participating player's ante and play wagers that remains in play may be collected and retained by the dealer.

Optionally, the bonus wager of each participating player who has placed a bonus wager in the bonus wager region 166 may be resolved according to the set of player cards of that player. By way of example and not limitation, the bonus wager may be resolved, and a fixed odds payout paid, according to a bonus pay table (see, e.g., Table II above).

The bonus payout may be paid to any participating player who has elected to make the bonus wager prior to receiving and/or inspecting his or her player cards and who holds a qualifying set of player cards according to the bonus pay table. For any participating player that does not hold a player card hand with at least a three-card alternating color straight, that participating player's bonus wager may be retained by the dealer and/or house.

After any remaining portions of the ante, bonus, and play wagers are resolved and payouts (if any) are paid and/or wagers collected and retained, the player cards and dealer cards may be collected and the game round ended.

In some embodiments, the fixed odds payout of the ante and player wagers, the bonus pay table, and/or the combinations thereof, may be adjusted based on a number of cards or decks of cards used in the game play. Thus, the game may be played with any number of cards or decks of cards, such as with a single 52-card deck, two 52-card decks, three 52-card decks, four 52-card decks, decks with one or more jokers, etc. Given the number of cards or decks of cards, the bonus pay table may be adjusted based on the odds of obtaining the winning hand(s). Thus, a card shuffler, dealing shoe, stack, or digital file containing any number of cards or representations of cards may be used with embodiments of the present disclosure.

The method 100 of administering the game of the present disclosure, as described above with reference to FIGS. 1 through 3, may be based solely on the occurrence, non-occurrence, length (e.g., run), and/or comparative length (i.e., the number of cards) of alternating color straights. Thus, other conventional poker card combinations, such as full house, pair, three of a kind, flush, suited straights, etc., may be disregarded in administering the game of the present disclosure. It is understood that considering only or solely alternating straights may include the consideration of the final card or a highest ranked card of the alternating straight in a predetermined tiebreaking situation, as described above.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 14 is a flowchart diagram of a method 900 of administering a wagering game in accordance with the present disclosure. In some embodiments, the method 900 of administering a wagering game may be similar to and may include one or more of the various portions, configurations, and options of the method 100 of administering a wagering game discussed above with reference to FIGS. 1 through 3.

As shown in FIG. 14, the method 900 includes administering a wagering game in which one or more winners may be determined by comparing card sequences (e.g., straights) of at least two sets of cards where each straight includes at least one alternating element such as the color of the suit. The method 900 may begin with the acceptance by the dealer from a player of an ante bet and a bonus wager (e.g., a Super Bonus wager, which may be a mandatory wager in order to participate in the wagering game), or receiving an indication that the wagers have been made or received from each participating player, or at a location associated with a particular player, as indicated at operation 902. In some embodiments, the Super Bonus wager may be a multiple of the ante wager (e.g., 1×, 2×, 3×, etc.).

The Super Bonus wager may be based on the margin of victory of the player hand over the dealer hand, in the event that the player hand beats the dealer hand. For example, the margin of victory may be defined by a difference in the number of cards forming the dealer and player straights where the number of player cards exceeds the number of dealer cards according to the odds shown in Table III.

TABLE III

| Player Wins By | Bonus Payout |
|---|---|
| 6 Additional Cards | 1,000 to 1 |
| 5 Additional Cards | 100 to 1 |
| 4 Additional Cards | 20 to 1 |
| 3 Additional Cards | 10 to 1 |
| 2 Additional Cards | 2 to 1 |
| Less than 2 Additional Cards | Push |

By way of example, if the player hand contains an alternating straight of six cards and the dealer hand contains an alternating straight of three cards, the player would receive a bonus payout of 10 to 1 for having an alternating straight formed with three additional cards as compared to the dealer hand.

If the player hand does not beat the dealer hand by the selected margin of victory, the Super Bonus wager may be retained by the dealer. In some embodiments, the Super Bonus wager may push in the event that the player hand beats the dealer hand, but does not qualify for a bonus (e.g., where the player hand beats the dealer hand by less than two additional cards).

In some embodiments, optionally, an additional bonus wager (i.e., in addition to the Super Bonus wager discussed above) may be accepted from at least one participating player, as indicated at operation 904. In some embodiments, such an additional bonus may be similar to or the same as the bonus wager discussed above in relation to operation 104 of method 100. For example, the bonus wager may include a wager that the player cards of the at least one participating player will include an alternating straight of a minimum number of cards (e.g., at least three cards, at least four cards).

After the ante wager and any bonus wagers have been accepted, player cards may be dealt to each participating player, as indicated at operation 906. Another set of cards against which each participating player's set of playing cards is to be played (e.g., dealer cards) may be dealt face down, such as in front of the dealer, as indicated at operation 908. Each participating player may be allowed to inspect his or her set of player cards, as indicated at operation 910 (e.g., prior to revealing the dealer cards) and arrange the cards into the longest straight of alternating suit color. After inspecting his or her set of player cards, each participating player may be allowed to fold or place a play wager to continue playing the game, as indicated at operation 912.

After each participating player has folded or placed a play wager, the set of dealer cards may be revealed and the set of player cards of each participating player who placed a play wager may be compared to the set of dealer cards. The ante and play wagers of each participating player who placed a play wager may be resolved based on the comparison of the player and dealer cards, as indicated at operation 914. If applicable, the additional bonus wager may be resolved according to a bonus pay table and based on whether the set of player cards of each participating player from whom a bonus wager was accepted includes a longest alternating color straight of a predetermined minimum number of cards (e.g., an alternating color straight of at least three cards), as indicated at operation 916.

The Super Bonus wager may be resolved according to a pay table (e.g., Table III above) based on the difference in the number of cards forming the dealer and player straights where the number of player cards exceeds the number of cards in the dealer straight, as indicated at operation 917.

After the ante wager, Super bonus wager (if any), bonus wager (if any), and play wager (if any) have been resolved and winning payouts paid to any qualifying participating player(s), any losing ante, bonus, and play wagers may be retained by the casino or other gaming establishment, as indicated at operation 918.

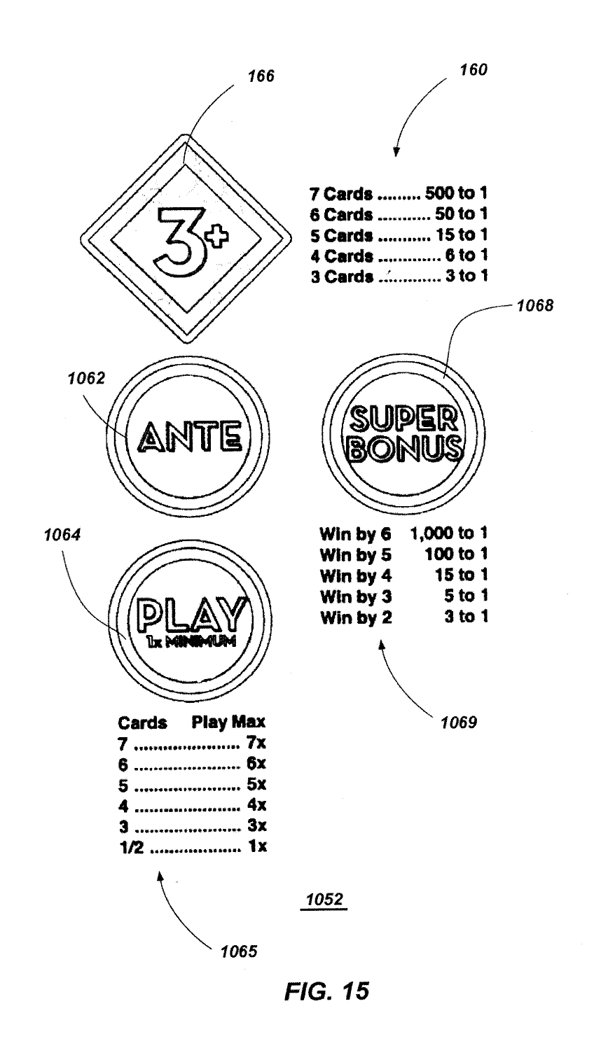

FIG. 15 is an enlarged diagram of a player position 1052 of a playing surface for implementation of the wagering game. In some embodiments, player position 1052 may be similar to player position 152 discussed above in relation to FIG. 3 and multiple player positions 1052 may be implemented on a playing surface (e.g., playing surface 150 (FIG. 2)). As shown in FIG. 15, each player position 1052 may include an ante wager region 1062 within which money or representations of money may be placed or displayed (e.g., physically positioned or digitally displayed) when the ante wager is accepted. Each player position 1052 may also include a play wager region 1064 within which a play wager may be placed when the participating player decides not to fold and the play wager is accepted. In some embodiments, a table 1065 may be positioned proximate to the play wager region 1064 to indicate the maximum allowed play wager, which, as discussed above, may be based on a multiple (e.g., a multiple of the ante wager) where the maximum allowed multiple is dependent on the number of cards in the player hand forming the alternating straight (e.g., Table I).

Each player position 1052 may include a second bonus wager region 1068 within which a second bonus wager (e.g., a Super Bonus wager) may be placed or displayed when the second bonus wager is accepted. As above, in one embodiment, such a second bonus wager is based on the margin of victory of the player hand over the dealer hand, in the event that the player hand beats the dealer hand. In some embodiments, the second bonus wager region 1068 may be positioned proximate to a pay table 1069, which may display the payout odds associated with each winning bonus hand (e.g., Table III).

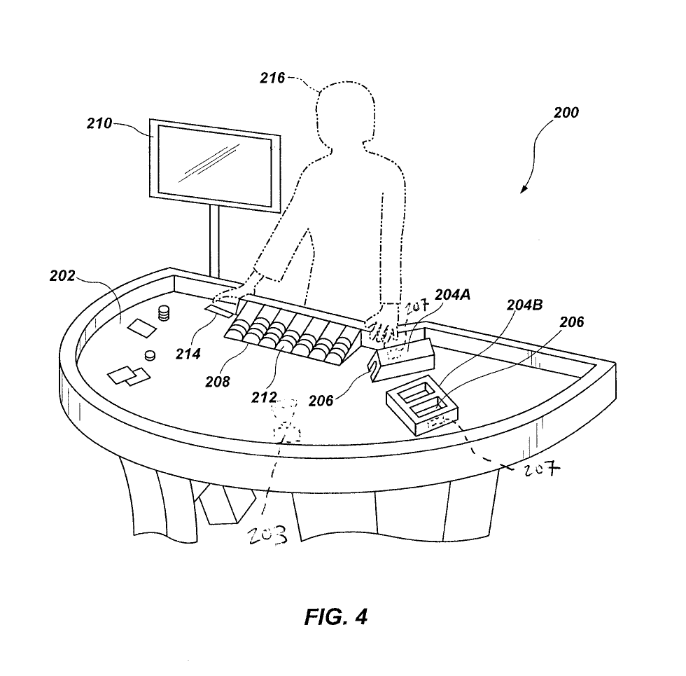

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203 (shown in dashed lines), which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, non-limiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, pay tables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time. Such a card-handling device 204A may include a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference. The card-handling device 204B may be, for example, a shuffler configured to reorder physical cards 206 from one or more decks of playing cards and present randomized cards 206 for use in the wagering game. Such a card-handling device 204B may include a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. The card-handling device 204 may also be, for example, a combination shuffler and shoe in which the output for the shuffler is a shoe. The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc.

In some embodiments, the card-handling device 204 may include an electronic display 207 (shown in dashed lines) for displaying information related to the wagering game being administered. For example, the electronic display 207 may display a menu of game options, the game selected, the number of cards per hand to be dispensed, acceptable amounts for wagers (e.g., maximums and minimums), numbers of cards to be dealt to recipients, locations of particular recipients for particular cards, winning and losing wagers, pay tables, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific to the game to be implemented. For example, card-handling device 204 may comprise an automatic shuffle that is configured to provide packets of cards (e.g., seven cards making the entire player or dealer's hand) to the dealer.

When administering a wagering game in accordance with embodiments of this disclosure, a dealer 216 (shown in phantom) may receive money (e.g., cash) from a player in exchange for wagering elements 212. The dealer 216 may deposit the money in the deposit 214 and transfer physical wagering elements 212 to the player. The dealer 216 may accept one or more initial wagers (e.g., antes and other wagers) from the player, which may be reflected by the dealer 216 permitting the player to place one or more wagering tokens 212 or other wagering elements (e.g., cash) within designated areas on the gaming surface 202 associated with the various wagers of the wagering game. Once initial wagers have been accepted, the dealer 216 may remove physical cards 206 from the card-handling device 204 and position them within designated areas on the gaming surface 202, which may designate the cards 206 for use as individual player cards, community cards, or dealer cards in accordance with game rules. House rules also may allow the player to place wagers during card distribution, or after card distribution, but before revealing the cards.

After dealing the cards 206, and during play, according to the game rules, any additional wagers (e.g., play bets) may be accepted, which may be reflected by the dealer 216 permitting the player to place one or more wagering tokens 212 within designated areas on the gaming surface 202 associated with the various wagers of the wagering game. In some embodiments, a player may fold, which may result in the dealer 216 collecting at least one of the wagering tokens 212 from that player and transferring it to the house, which may be reflected by the wagering token 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering tokens 212 from the chip rack 208 to the players, and transferring losing wagers to the house, which may be accomplished by moving wagering tokens 212 from the players to the chip rack 208.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touch screens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smartphone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices such as a server through a suitable communication medium, such as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play, and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

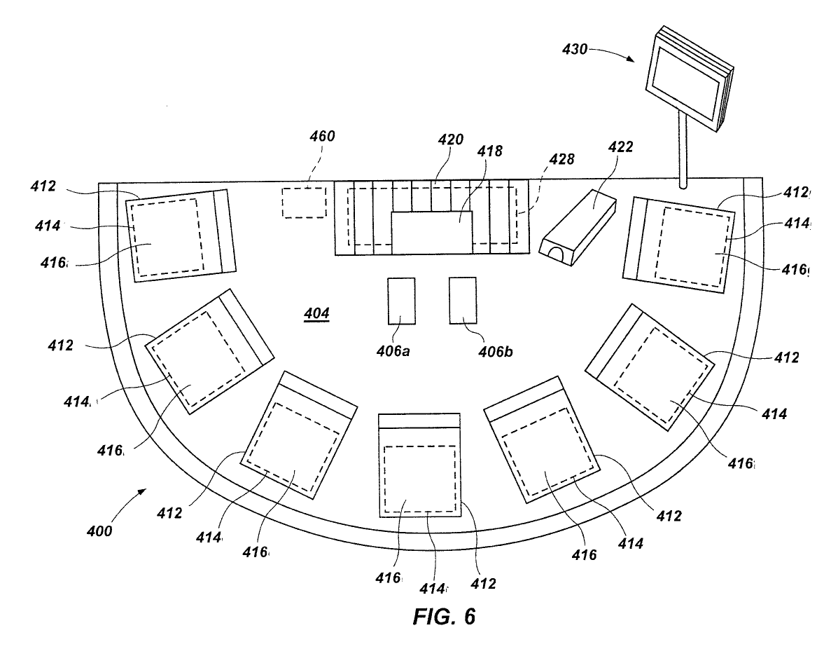

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc., and accepting player elections). The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 (shown in dashed lines) may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double-sided to provide such information to players as well as to casino pit personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

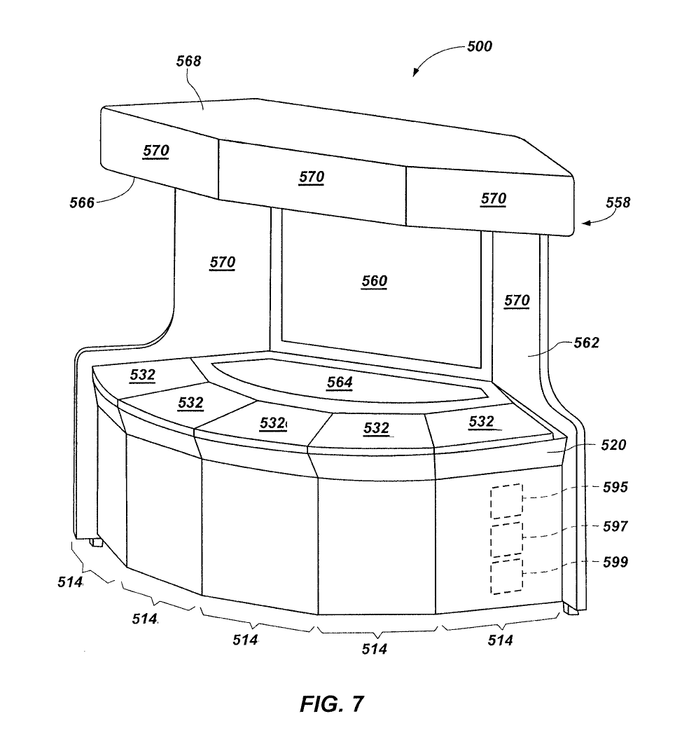

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices such as a central server through a suitable communication medium, such, as, for example, wired networks, Wi-Fi networks, and cellular communication networks.

The video device 558 may further include banners communicating rules of play, and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client—server architecture (e.g., over the Internet, a local area network, etc.). FIG. 8 is a schematic block diagram of an exemplary gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In embodiments, games are accessed through a user interaction service 612. The gaming system 600 enables players to interact with a user device 620 through a user input device 624 and a display 622 and to communicate with the one or more gaming servers 610 using a network 630 (e.g., the Internet). Typically, the user device is remote from the gaming server 610 and the network is the world wide web (i.e., Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated by one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may comprise game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be performed to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the user and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, non-limiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino web page (or other interface) indicating that the client is embedded into a web page, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

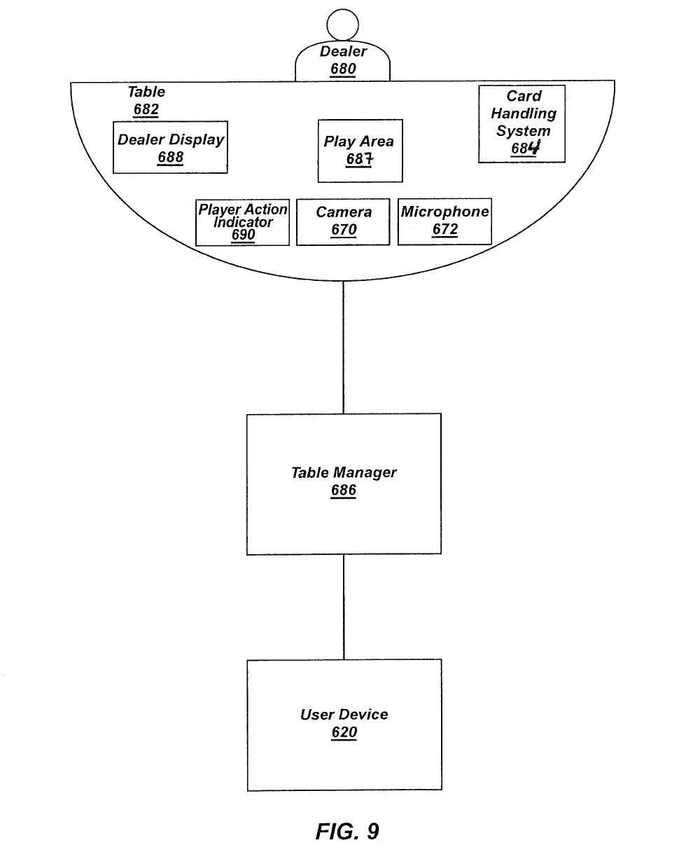

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by a computerized random processes, physical cards (e.g., from a standard, 52-card deck of playing cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example. Examples of card data include: suit and rank information of a hand, and suit and rank data of every hand in a round of play.

The live video feed permits the dealer 680 to show cards dealt by the card handling system 684 and play the game as though the player were at a live casino. In addition, the dealer 680 can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card handling system 684 may be as shown and described previously in connection with FIG. 4. The play area 687 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card, and/or hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example.

The live video feed permits the dealer 680 to show cards dealt by the card handling system 684 and play the game as though the player were at a live casino. In addition, the dealer 680 can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

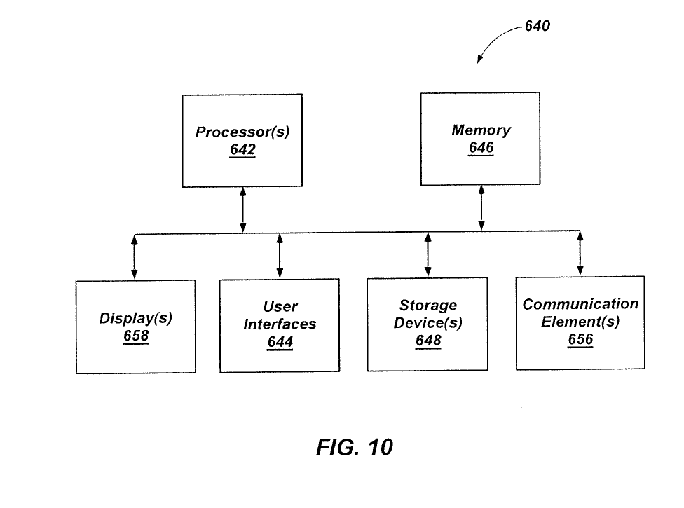

FIG. 10 is a simplified block diagram showing elements of computing devices that may be used in systems and apparatuses of this disclosure. The computing system 640 may be a user-type computer, a file server, a computer server, a notebook computer, a tablet, a hand-held device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light-emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push buttons, mice, joysticks, haptic devices, microphones, speakers, cameras, and touch screens.

As non-limiting examples, the communication elements 656 may be configured for communicating with other devices or communication networks. As non-limiting examples, the communication elements 656 may include elements for communicating on wired and wireless communication media, such as, for example, serial ports, parallel ports, Ethernet connections, universal serial bus (USB) connections, IEEE 1394 (“firewire”) connections, THUNDERBOLT™ connections, BLUETOOTH® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one non-limiting example, the memory 646 may be divided into cache memory, graphics memory, and main memory. Each of these memories may communicate directly or indirectly with the one or more processors 642 on separate buses, partially combined buses, or a common bus.

In some embodiments, wagering games may be administered in an at least partially player-pooled format, with payouts on pooled wagers being paid from a pot to players and losses on wagers being collected into the pot and eventually distributed to one or more players. Such player-pooled embodiments may include a player-pooled progressive embodiment, in which a pot is eventually distributed when a predetermined progressive-winning hand combination or composition is dealt. Player-pooled embodiments may also include a dividend refund embodiment, in which at least a portion of the pot is eventually distributed in the form of a refund distributed, e.g., pro-rata, to the players who contributed to the pot.

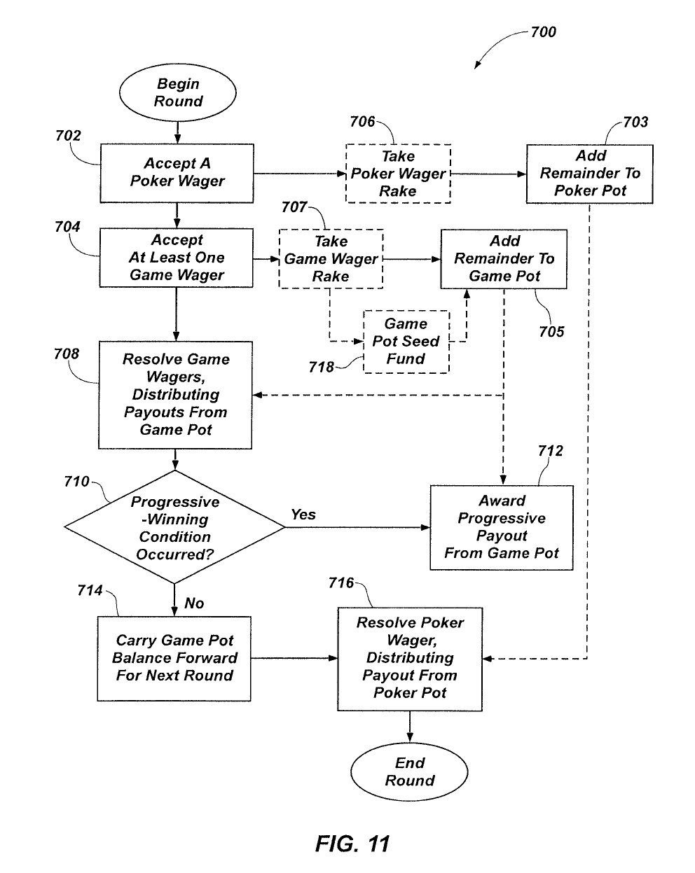

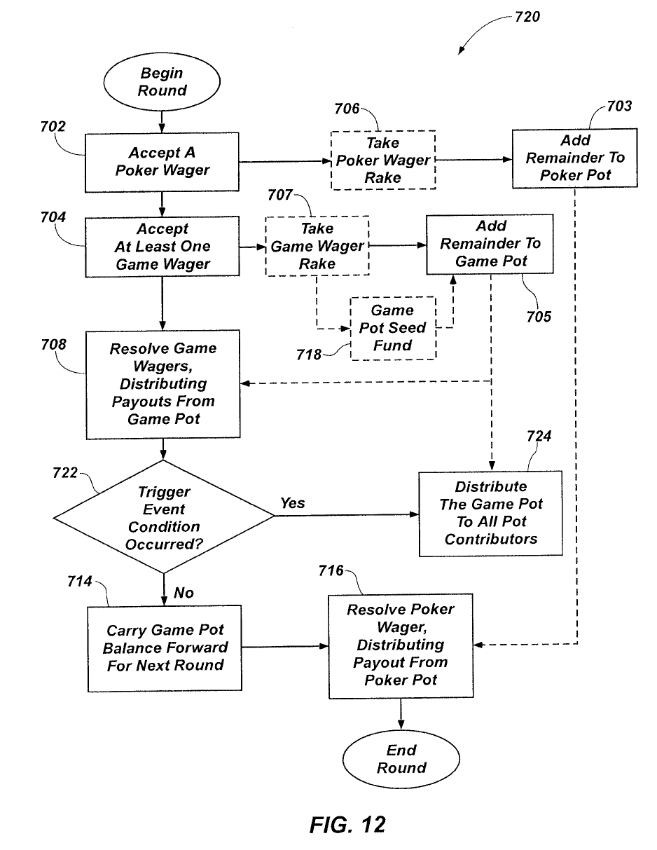

In some player-pooled embodiments, the game administrator may not obtain profits from chance-based events occurring in the wagering games that result in lost wagers. Instead, lost wagers may be redistributed back to the players. To profit from the wagering game, the game administrator may retain a commission, such as, for example, a player entrance fee or a rake taken on wagers, such that the amount obtained by the game administrator in exchange for hosting the wagering game is limited to the commission and is not based on the chance events occurring in the wagering game itself. The game administrator may also charge a rent or flat fee to participate. Specific, illustrative mechanisms for redistributing the lost wagers back to players are described in connection with FIGS. 11 and 12.

Referring to FIG. 11, shown is a flowchart diagram of a method 700 of administering a wagering game, which may be at least partially player-pooled, according to a player-pooled progressive embodiment. The method 700 includes accepting a first mandatory wager, referred to herein as a “poker wager,” as indicated at 702. At least a portion of the poker wager is added to a poker pot, as indicated at operation 703. The poker wager may be later resolved by comparing player hands and awarding the poker pot, or at least a portion thereof, to the player holding a highest ranking alternating straight in that round of play. For example, in a seven card game, an alternating straight of four cards would outrank an alternating straight of three cards.

The poker pot may be a nonprogressive pot; more specifically, all or substantially all of the poker pot may be distributed at the conclusion of each round of the wagering game. In some embodiments, the poker wager may be a mandatory wager to qualify the player for play of the underlying wagering game. In other embodiments, the poker wager may be optional, and the wagering game may be administered to a player without receiving the poker wager and without qualifying the player for a potential payout from the poker pot.

At least one game wager may also be accepted, as indicated at 704. The game wagers may include, for example, base game wagers (e.g., ante wagers, blind wagers, play wagers, raises, and other wagers made on the underlying wagering game), side wagers, or both. More specifically, the game wagers may comprise, for example, the ante wager, the play wager, and the bonus wager. At least a portion of each game wager is added to a game pot, as indicated at operation 705, which game pot may be a progressive pot.

In some embodiments, acceptance of the at least one game wager qualifies a player to be eligible to win an award in addition to the payouts available from the underlying game (i.e., the ante wager, the play wager, and the bonus wager), such as, for example, a progressive payout (e.g., a progressive jackpot awarded to one or more qualifying players). Therefore, in some such embodiments, a progressive wager may be received, in addition to the other game wagers received from the player, such as the ante wager, the play wager, and the bonus wager. In other such embodiments, one of the game wagers may be converted to a progressive wager, such as, for example, the ante wager, the play wager, and the bonus wager. In some embodiments, the progressive wager may be a mandatory wager to qualify the player for play of the underlying wagering game. In other embodiments, the progressive wager may be optional, and the wagering game may be administered to a player without receiving the progressive wager, in addition to any other game wagers, from the player and without qualifying the player to be eligible to win the progressive payout from the game pot.

In some embodiments, the poker wager and the at least one game wager may be received as indistinct wagers, with a portion thereof being designated for the poker pot (a non-progressive pot) and another portion being designated for the game pot (a progressive pot).

In some embodiments, the game pot may be a pooled or linked pot. For example, the game pot may include one or more game wagers accepted from multiple concurrent wagering games. As another example, the game pot may include pooled progressive wagers from those wagering games currently being played and may include accumulated game wagers from past wagering games. As specific, non-limiting examples, the game pot may include all game wagers accepted from a group of electronic gaming tables or other local wagering game administration devices at a casino, from multiple groups of remote devices connected to network gaming architecture, or both. In other embodiments, the game pot may not be pooled, and awards for the game wager may be limited to the amounts wagered at a respective electronic gaming table, other local wagering game administration device, or group of remote devices.

The game administrator may take a “rake” (e.g., a commission for the house) on at least one wager, such as the poker wager, as indicated at operation 706, the at least one game wager, as indicated at operation 707, or both. In some embodiments, therefore, a rake may be taken on all wagers, or any wager. For example, the house may collect a portion of the poker wager at the time the poker wager is placed. Additionally or alternatively, the house may collect a portion of the game wagers at the time the game wagers are placed.

The rake may be, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, non-limiting examples, the percentage of the wagers (i.e., either or both of the poker wager and the at least one game wager) collected for the rake may be between 3% and 8%, between 4% and 7%, or between 5% and 6%. In other embodiments, the portion of the wagers collected for the rake may be a variable percentage of the wagers or may be a fixed quantity (e.g., a flat fee) irrespective of the total amount for the wagers, a fixed percentage with a cap, or a time-based fee for increments of time playing the wagering game. Thus, in lieu of, or in addition to, a rake taken on one or more wagers, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some player-banked embodiments. In such embodiments, wagered amounts in excess of the rake are distributed either in the form of, for example, a progressive payout (as in a “player-pooled progressive” embodiment (FIG. 11)), a dividend refund (as in a “dividend refund” embodiment (FIG. 12)), or some combination thereof. Thus, the profits for the house may be limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., the ante wager, the play wager, and the bonus wager), including losses resulting from optimal and suboptimal play.

The rake may be maintained in a rake account, and profits for the house may be deducted from the rake account. When and if taken from the poker wagers, the poker wager rake (operation 706) may be taken by, for example, electronically transferring funds from the poker wagers to a poker pot rake account (e.g., as instructed by a game service 616 (see FIG. 8) using casino account servers 632 (see FIG. 8)). Likewise, when and if taken from the game wagers, the game wager rake (operation 707) may be taken by, e.g., electronically transferring funds from the game pot wagers to a game pot rake account (e.g., as instructed by the game service 616 (see FIG. 8) using casino account servers 632 (see FIG. 8)).

In some embodiments, the poker wager may be accepted (operation 702) at the beginning of a round of administration of the wagering game. One or more of the game wagers may be accepted (operation 704) at the beginning of the round as well, e.g., the ante wager, the play wager, and the bonus wager. In some embodiments, additional game wagers may be accepted (operation 704), possibly raked (operation 707), and added to the game pot (operation 705) in the intermediate segments of the round of play, e.g., the ante wager, the play wager, and the bonus wager.

The underlying wagering game may be played as described above, including resolving the game wagers received during the round of play, as indicated at operation 708. For example, the underlying wagering game may be played at least substantially as described previously in connection with FIGS. 1 through 3. Payouts to be distributed, as a result of resolving the game wagers, (e.g., the ante wager, the play wager, and the bonus wager), are paid from the game pot.

It is contemplated that only a portion of the game pot may be distributed, at operation 708, in the form of payouts on the underlying game. At least in embodiments in which the game pot is configured as a progressive pot (e.g., if one of the game wagers is a progressive wager or one game outcome of a low frequency pays the amount of the pot), all or substantially all of the remaining portion of the game pot may be designated for a potential progressive payout. For example, administering the player-pooled progressive embodiment of the player-pooled wagering game may include determining whether a progressive-winning condition has occurred, as indicated at operation 710. A progressive-winning condition may be predefined as a predetermined winning hand combination being dealt, which may result in an award of, for example, a portion of the game pot, or a premium winning hand composition being dealt, which may result in an award of, for example, an entire amount of the game pot. If such a progressive-winning condition has occurred during the round of game administration, a progressive payout may be awarded to the winning-hand-holding player, with the progressive payout being paid from the game pot, as indicated at operation 712. As just one example, a game may pay a progressive payout for an alternating color straight of a predetermined length, for example, an alternating color straight using a majority or an entirety of the cards dealt to the player (e.g., six cards, seven cards). If no progressive-winning condition has occurred, a progressive payout may not be paid from the game pot, but, rather, the game pot balance may be carried forward for the next round of play and so on, as indicated at operation 714, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts distributed at operation 708, or if a progressive payout is awarded at operation 712, without draining the game pot, the game pot may decrement until the game pot contributions, at operation 705, rebuild the game pot.

A predetermined winning hand combination may be, for example, an alternating color straight of three cards, an alternating straight of four cards, or an alternating straight of five cards. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may be, for example, an alternating color straight using a majority or an entirety of the cards dealt to the player (e.g., six cards, seven cards). The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, non-limiting example, after identification of a player hand achieving a straight flush, the hand compositions qualifying as premium winning hand compositions may be restricted to royal flushes or may be expanded to include four-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may involve crediting a player account with funds from the game pot or may comprise distributing physical money or physical representations of money from the game pot to the player.

Before, between, or after resolving the game wagers (operation 708), determining whether a progressive-winning condition occurred (operation 710), awarding a progressive payout (operation 712), or any combination thereof, the poker wager may be resolved, and the poker pot may be awarded to at least one player, as indicated at operation 716. Each successive round of receiving wagers, dealing cards, and resolving wagers may constitute a round of play, and the poker pot may be awarded to at least one player before the end of each round of play. The player to whom the poker pot is awarded may hold a highest-ranking hand of all hands dealt in a round on a table using conventional poker rankings, or a ranking system specific to the disclosed games (e.g., a longest alternating straight) when compared to the hands of other players at the virtual “table.”

Awarding the poker pot or the portion of the poker pot may involve crediting a player account of each winning player or may comprise distributing physical money or physical representations of money to each winning player.

In some embodiments, an entire amount of the poker pot may be awarded to at least one player before the end of each round of play. In such embodiments, the poker pot may be a nonprogressive pot. Awarding the entire amount of a poker pot to at least one player at the end of each round of play redistributes lost poker wagers attributable to suboptimal play to other players, rather than to the house.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 718) at the beginning of play, after the game pot or a portion of the game pot has been awarded, or both. In some embodiments, a minimum account balance sufficient to cover expected losses is retained when distributing a progressive payout (operation 712) such that no seed money is required in the game pot. For example, the game pot may be seeded from the rake account of the house (operation 718), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed-odds payout is to be awarded to the player holding the predetermined winning hand combination, the amount seeded to the game pot between those rounds of play may be at least as great as the maximum fixed-odds payout awardable for any predetermined winning hand combination. The game pot may be seeded each time the game pot is awarded in its entirety or each time the amount in the game pot is lower than the maximum fixed-odds payout.

FIG. 12 is a flowchart diagram of a method 720 of administering a wagering game, which may be at least partially player-pooled, according to a dividend refund embodiment. The method 720 is largely the same as the method 700 of the player-pooled progressive (FIG. 11), with the exception that, rather than determining whether a progressive-winning condition has occurred (operation 710 (FIG. 11)), the method 720 includes determining whether a trigger event condition has occurred, as indicated at operation 722, and, if so, distributing the game pot to one or more past or present players of the wagering game, as indicated at operation 724 (rather than distributing the game pot as a progressive payout as at operation 712 (FIG. 11)). In such an embodiment, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but is a refund.

The game pot may be distributed among a plurality of players upon the occurrence of a predetermined event (referred to herein as a “trigger event”), as indicated at operation 722. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, amount based, or other-based. Further details on pot distributions based on predetermined trigger events and conditions are disclosed in the U.S. patent application Ser. No. 13/871,824, filed Apr. 26, 2013, and titled “DISTRIBUTING SUPPLEMENTAL POT IN WAGERING GAMES BASED ON PREDETERMINED EVENT,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in his or her player account.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given non-monetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher-level players, or players who have invested more time playing the game may be allotted more wagering elements per unit of time than a player assigned to a lower level group.

Therefore, in some embodiments, the wagering game may be administered by receiving wagers (e.g., the ante wager, the play wager, and the bonus wager) of no real-world monetary value, and payouts (e.g., the ante wager, the play wager, and the bonus wager) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

### Example

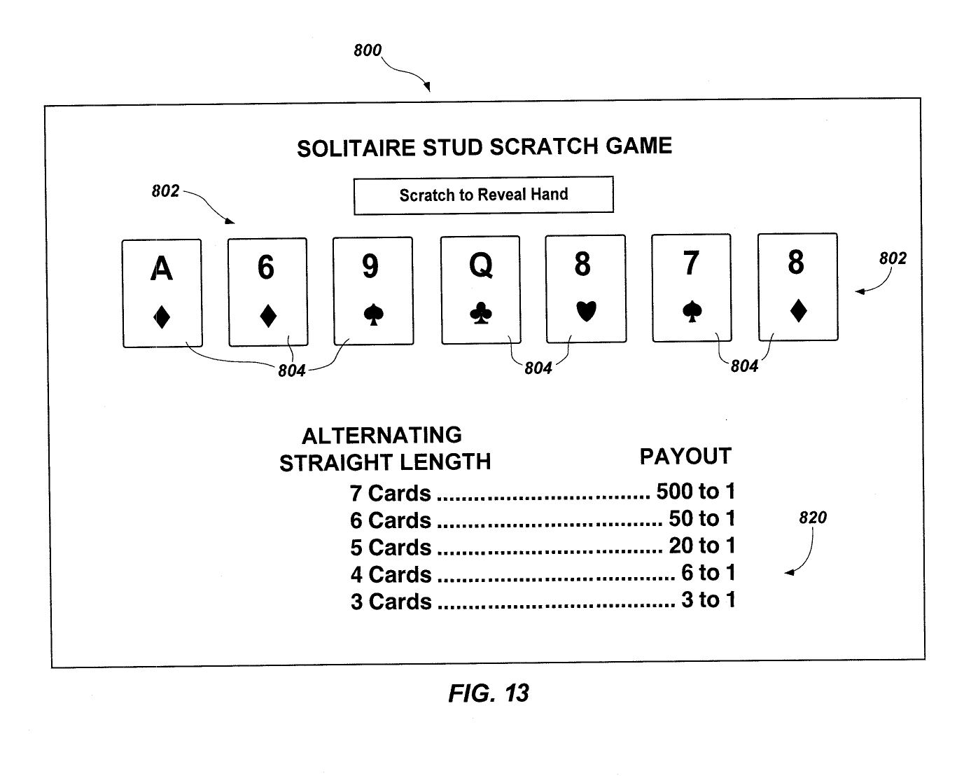

With reference to FIG. 13, a schematic diagram of a wagering game implemented as a scratch card 800 is shown, according to an embodiment of the present disclosure. The scratch card 800 may be implemented as a physical scratch card or a digital scratch card, for example. If the scratch card 800 is a physical scratch card, then representations of cards may be initially covered by an opaque scratch-off covering that may be removed by, for example, scratching off the covering with a coin, fingernail, etc., as is known in the art. If the scratch card 800 is a digital scratch card, then representations of cards may be obscured digitally, or may be stored only in memory, and the representations of cards may be revealed or shown by selecting the location of the representation of cards (e.g., by a mouse click, touching a touch screen, toggling through the representations then selecting “enter,” etc.) or by effecting a motion that represents scratching (e.g., by holding down a mouse button and passing a digital cursor back and forth across the representation, by back and forth motions with a finger on a touch screen, etc.).

The scratch card 800 may include a player card area 802 in which representations of cards 804 are to be positioned. In the embodiment shown in FIG. 13, the player card area 802 includes seven representations of cards 804. Although the rank and suit of the representations of cards are shown in FIG. 13 for ease of explanation, when a participating player initially purchases the scratch card 800, the rank and suit of the representations of cards may be obscured and undetectable by the participating player.

If the scratch card 800 is a physical scratch card, the rank and suit of each representation of card may be determined by a random number generator at the time of printing the scratch card 800. If the scratch card 800 is a digital scratch card implemented on a computer system or network, for example, the rank and suit of each representation of card may be determined by a random number generator associated with the digital scratch card and/or the computer system or network that implements the digital scratch card 800.

Referring to FIG. 13, a participating player may purchase the scratch card 800 from an establishment, such as, for example, for a fixed price of $1 (or another fixed price), for example. To illustrate how embodiments of the wagering game are played using the scratch card 800, the participating player may reveal the requisite number (e.g., seven in the embodiment shown in FIG. 13) of representations of cards 804 in the card area 802. For purposes of illustration and by way of non-limiting example, the revealed representations of cards 804 in the card area 802 may be an ace of diamonds, a 6 of diamonds, a 9 of spades, a queen of clubs, an 8 of hearts, a 7 of spades, and an 8 of diamonds. With these revealed representations of cards 804, the longest alternating color straight may be formed by a 6 of diamonds, a 7 of spades, an 8 of hearts (or diamonds), and a 9 of spades for an alternating color straight of four cards. Accordingly, the player has achieved a four-card longest alternating color straight. Thus, the player has won a 6 to 1 payout or $6.00 according to a pay table 820 (e.g., based on the amount paid for the scratch card 800), and the establishment from which the scratch card 800 was purchased or another establishment responsible for providing payouts may accept the scratch card 800 with card faces revealed and pay an appropriate payout to the participating player according to the pay table 820. This embodiment shows a scratch ticket version of the bonus game against a pay table. In other embodiments, the scratch ticket provides a player hand and a dealer hand. The player buys the ticket. The purchase price is equal to the ante and play bet. In other words, the hand is played “blind.” The player scratches both hands and compares the longest alternating color straight in both hands. If the player straight has more cards than the dealer hand, the players wins 1:1 on the purchase price of the ticket. If the dealer straight holds more cards, then the ticket is a loser. Embodiments of a scratch card game may include both a game against a dealer hand and a bonus bet.

Although the scratch card 800 has been described as being sold for a fixed price and as providing fixed payouts, the present disclosure is not so limited. For example, the scratch card 800 may be offered for sale at a variable price, and the pay table 820 may provide odds or multiples of the paid price as potential payouts. A purchase price at which a particular scratch card 800 is bought may be printed on the scratch card 800 at the time of sale. Thus, a participating player may wager more on the scratch card 800 by paying a higher price for the scratch card 800, and may qualify for a higher payout if a winning hand is achieved with the scratch card 800 purchased for a higher price.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventors.

1. A method of administering a wagering game, comprising:
accepting an ante wager of at least one tangible gaming chip at a designated ante wager area on a gaming table layout from at least one participating player;
dealing a set of player cards from a set of physical playing cards to the at least one participating player at a playing card receiving area on the gaming table layout;
dealing a set of dealer cards from the set of physical playing cards to a dealer card receiving area on the gaming table layout;
allowing the at least one participating player to inspect the set of player cards associated with the at least one participating player;
accepting a play wager of at least one tangible gaming chip at a play wager area on the at least one player position from the at least one participating player or an indication of folding from the at least one participating player, wherein a maximum amount of the play wager is based upon a number of cards in a longest alternating straight of the set of player cards of the at least one participating player; and
resolving the wager, comprising:
comparing only the longest alternating straight of the set of player cards of the at least one participating player with a longest alternating straight of the set of dealer cards; and
paying a payout on the ante wager and the play wager comprising at least one tangible gaming chip to the at least one participating player when the longest alternating straight of the set of player cards has a greater number of cards than the longest alternating straight of the set of dealer cards.

2. The method of claim 1, further comprising selecting the longest alternating straight of the set of player cards of the at least one participating player and the longest alternating straight of the set of dealer cards to each comprise a sequence where each card of the sequence of cards is of a differing color than each adjacent card in the sequence of cards.

3. The method of claim 1, further comprising selecting the set of player cards and the set of dealer cards to each consist of seven cards.

4. The method of claim 1, further comprising selecting the maximum amount of the play wager to be based on a multiple of the ante wager.

5. The method of claim 4, further comprising selecting the maximum amount of the play wager according to the following table.

| Number of Cards in the | |
|---|---|
| Longest Alternating Straight | Maximum Play Wager |
| 1 or 2 | 1x ante wager |
| 3 | 3x ante wager |
| 4 | 4x ante wager |
| 5 | 5x ante wager |
| 6 | 6x ante wager |
| 7 | 7x ante wager |

6. The method of claim 1, further comprising accepting a bonus wager of at least one tangible gaming chip on an occurrence of the longest alternating straight of the set of player cards of the at least one participating player including at least two more cards than the longest alternating straight of the set of dealer cards.

7. The method of claim 6, further comprising paying the bonus wager to the at least one participating player according to the following pay table:

| Player Wins By | Bonus Payout |
|---|---|
| 6 Additional Cards | 1,000 to 1 |
| 5 Additional Cards | 100 to 1 |
| 4 Additional Cards | 20 to 1 |
| 3 Additional Cards | 10 to 1 |
| 2 Additional Cards | 2 to 1 |
| Less than 2 Additional Cards | Push |

8. The method of claim 1, further comprising, when a number of cards in the longest alternating straight of the set of player cards of the at least one participating player is equal to a number of cards in the longest alternating straight of cards of the set of dealer cards, paying a payout on the wager if a highest-ranking card in the longest alternating straight of the set of player cards of the at least one participating player is greater than a highest-ranking card in the longest alternating straight of cards of the set of dealer cards.

9. The method of claim 8, further comprising returning the ante wager and play wager if the highest-ranking card in the longest alternating straight of the set of player cards of the at least one participating player is equal to the highest-ranking card in the longest alternating straight of cards of the set of dealer cards.

10. The method of claim 1, further comprising returning the ante wager to the at least one participating player if a number of cards in the longest alternating straight of cards of the set of dealer cards is less than three cards and a highest-ranking card of the longest alternating straight of cards of the set of dealer cards has a rank less than 5.

11. A method of administering a wagering game, comprising:
accepting a wager of at least one tangible gaming chip at a designated wager area on a gaming table layout from at least one participating player;
accepting a bonus wager of at least one tangible gaming chip at a designated bonus wager area on the gaming table layout from the at least one participating player;
dealing a set of player cards from a set of physical playing cards to the at least one participating player at a playing card receiving area on the gaming table layout;
dealing a set of dealer cards from the set of physical playing cards to a dealer card receiving area on the gaming table layout;
allowing the at least one participating player to inspect the set of player cards associated with the at least one participating player;
resolving the wager, comprising:
comparing only a longest alternating straight of the set of player cards of the at least one participating player with a longest alternating straight of the set of dealer cards; and
paying a payout on the bonus wager comprising at least one tangible gaming chip to the at least one participating player when the longest alternating straight of the set of player cards has a greater number of cards than the longest alternating straight of the set of dealer cards; and
resolving the bonus wager comprising paying a payout on the wager comprising at least one tangible gaming chip to the at least one participating player when the longest alternating straight of the set of player cards of the at least one participating player includes at least two more cards than the longest alternating straight of the set of dealer cards.

12. The method of claim 11, further comprising requiring the bonus wager with the wager for participation in the wagering game by the at least one participating player.

13. The method of claim 11, further comprising returning the bonus wager if the longest alternating straight of the set of player cards of the at least one participating player includes less than two additional cards than the longest alternating straight of the set of dealer cards and if the longest alternating straight of the set of player cards has a greater number of cards than the longest alternating straight of the set of dealer cards.

14. The method of claim 13, further comprising returning the bonus wager if a number of cards of the longest alternating straight of the set of player cards is equal to a number of cards of the longest alternating straight of the set of dealer cards and if a highest-ranking card in the longest alternating straight of the set of player cards of the at least one participating player is greater than a highest-ranking card in the longest alternating straight of cards of the set of dealer cards.

15. The method of claim 11, further comprising paying the bonus wager to the at least one participating player according to the following pay table:

| Player Wins By | Bonus Payout |
|---|---|
| 6 Additional Cards | 1,000 to 1 |
| 5 Additional Cards | 100 to 1 |
| 4 Additional Cards | 20 to 1 |
| 3 Additional Cards | 10 to 1 |
| 2 Additional Cards | 2 to 1 |
| Less than 2 Additional Cards | Push |

16. The method of claim 11, further comprising accepting a play wager of at least one tangible gaming chip from the at least one participating player having a maximum amount based upon a number of cards in the longest alternating straight of the set of player cards of the at least one participating player.

17. The method of claim 16, further comprising selecting the maximum amount of the play wager to be based upon a multiple of the ante wager.

18. A method of administering a wagering game, comprising:
providing a gaming table layout comprising at least one player position and a dealer area, the at least one player position of the gaming table layout including an ante wager area, a play wager area, a first bonus wager area, a second bonus wager area, and a player card receiving area, the ante wager area, the play wager area, the first bonus area, and the second bonus wager area each defined by separate insignia displayed on the gaming table layout, the dealer area including a dealer card receiving area;
accepting an ante wager of at least one tangible gaming chip at the ante wager area from at least one participating player at the at least one player position;
accepting a first bonus wager of at least one tangible gaming chip at the first bonus wager area from the at least one participating player;
optionally accepting a second bonus wager of at least one tangible gaming chip at the second bonus wager area from the at least one participating player at the at least one player position;
dealing a set of player cards from a randomized set of physical playing cards to the at least one participating player at the player card receiving area at the at least one player position;
dealing a set of dealer cards from the randomized set of physical playing cards to the dealer card receiving area;
allowing the at least one participating player to inspect the set of player cards associated with the at least one participating player;
accepting a play wager of at least one tangible gaming chip at the play wager area from the at least one participating player at the at least one player position or an indication of folding from the at least one participating player, wherein an maximum amount of the play wager is based upon a number of cards in a longest alternating straight of the set of player cards of the at least one participating player and a multiple of the ante wager;
determining the longest alternating straight with the set of player cards of the at least one participating player comprising a sequence of cards where each card is of a differing color than an adjacent card in the sequence of cards;
determining a longest alternating straight with the set of dealer cards comprising a sequence of cards where each card is of a differing color than an adjacent card in the sequence of cards;
resolving the ante wager and the play wager, comprising at least one of:
paying a payout comprising at least one tangible gaming chip on at least one of the ante wager and the play wager to the at least one participating player when the longest alternating straight of the set of player cards has a greater number of cards than the longest alternating straight of the set of dealer cards; and
retaining the ante wager and the play wager when the longest alternating straight of the set of player cards of the at least one participating player is shorter than the longest alternating straight of the set of dealer cards;
resolving the first bonus wager comprising paying a payout on the first bonus wager comprising at least one tangible gaming chip to the at least one participating player when the longest alternating straight of the set of player cards of the at least one participating player includes at least two more cards than the longest alternating straight of the set of dealer cards; and
resolving the second bonus wager, comprising at least one of:
paying a second bonus payout comprising at least one tangible gaming chip on the second bonus wager to the at least one participating player when the longest alternating straight of the set of player cards comprises at least three cards; and
retaining the second bonus wager if the longest alternating straight of the set of player cards comprises less than three cards.

19. A method of administering a wagering game over a network utilizing a processor, comprising:
receiving, at a processor, an indication that an ante wager to participate in the wagering game is accepted from at least one player;
determining, utilizing the processor, a player hand associated with the at least one player, the player hand including at least two randomized playing cards from a set of playing cards;
determining, utilizing the processor, a dealer hand, the dealer hand including at least two randomized playing cards from the set of playing cards;
providing, with the processor, the player hand to a user device associated with the at least one player for displaying the player hand on the associated user device;
determining, utilizing the processor, a longest alternating straight of the player hand comprising a sequence of cards where each card is of a differing color than an adjacent card in the sequence of cards;
receiving, at the processor, an indication that a play wager based upon a number of cards in the longest alternating straight of the player hand is accepted from the at least one player or an indication of folding from the at least one player;
determining, utilizing the processor, a longest alternating straight of the dealer hand where each card is of a differing color than an adjacent card in the sequence of cards;
providing, with the processor, the dealer hand to the user device associated with the at least one player for displaying the dealer hand on the associated user device; and
resolving, with the processor, the ante wager and the play wager by comparing a number of cards in the longest alternating straight of the player hand with a number of cards in the longest alternating straight of the dealer hand.

20. The method of claim 19, further comprising:
receiving, at the processor, an indication that a bonus wager is accepted from the at least one player; and
resolving, with the processor, the bonus wager by determining if the longest alternating straight of the set of player cards of the at least one player includes at least two more cards than the longest alternating straight of the set of dealer cards.
